(19) United States
(12) Patent Application Publication
(10) Pub. No.: US 2018/0223586 A1
(43) Pub. Date: Aug. 9, 2018

(54) DRIVE DEVICE FOR A DOOR LEAF OR WINDOW LEAF

(71) Applicant: GEZE GmbH, Leonberg (DE)

(72) Inventor: Matthias Hucker, Marxzell (DE)

(21) Appl. No.: 15/890,100

(22) Filed: Feb. 6, 2018

(30) Foreign Application Priority Data
Feb. 8, 2017 (DE) DE 102017201953.0

(51) Int. Cl. E05F 15/72; E05F 15/60

(52) U.S. Cl. CPC E05F 15/72; E05F 15/60; E05Y 2201/434; E05Y 2900/148; E05Y 2400/44; E05Y 2400/52; E05Y 2900/132; E05Y 2400/32

(57) ABSTRACT

A drive device for a leaf of a door, of a window or the like comprises a drive with a mechanical store which is charged by an opening movement of the leaf and is discharged with a closing movement of the leaf, at least one electric motor which is in operative connection with the leaf by means of at least one motor shaft and is operable as a generator for damping the leaf movements, and with open- and/or closed-loop control electronics for actuating the electric motor. The drive device also comprises a sensor system for monitoring at least one hazard zone in the region of the leaf. The electric motor is actuatable by means of the open- and/or closed-loop control electronics as a function of the output signals of the sensor system to make safe the hazard zone.

The invention relates to a drive device for a leaf of a door, of a window or the like, with a drive with a mechanical store which is charged by an opening movement of the leaf and is discharged with a closing movement of the leaf, at least one electric motor which is in operative connection with the leaf via at least one motor shaft and is operable as a generator for damping the leaf movements, and with open- and/or closed-loop control electronics for actuating the electric motor.

Drives or door closers for moving door leaves with a mechanical energy store and hydraulic damping are widely known. When the door leaf is opened manually the mechanical energy store is charged with potential energy which re-closes the released door leaf. The mechanical energy store may comprise, for example, a spring which is tensioned by the manual opening of the door leaf and is released when the door leaf is closed.

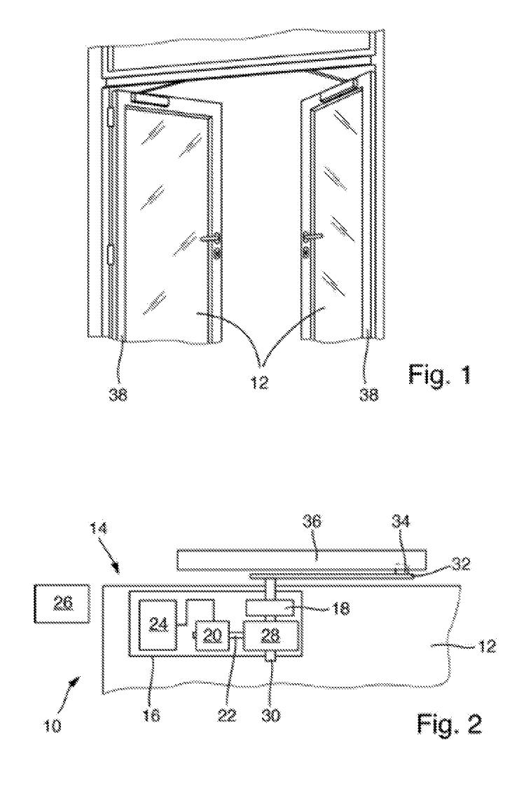

In most door structures on which hydraulic door closers are mounted, hazard areas are formed, particularly at the secondary closing edge, at which severe injuries may be caused, particularly to the fingers of a respective user, when the door leaf is automatically closed by the mechanical energy store. FIG. 1 of the attached drawings shows such hazard zones in the region of secondary closing edges in an exemplary schematic representation.

The hitherto conventional hydraulic door closers have no device for making safe hazard zones or for avoiding injuries in such hazard zones.

Although U.S. Pat. No. 7,571,515 has already described an obstacle sensor which can be connected to the control system of a hydraulically damped door closer, corresponding actuation of such a hydraulic door closer in the presence of an obstacle is relatively complex and is not generally adaptable to the respective situation.

Also known are generator damped door closers with at least one electric motor operable as a generator, whose motor shaft is in operative connection with the leaf and whose motor terminals can be short-circuited to damp the leaf movements via open- or closed-loop control electronics. In addition to a housing and a fitting for the connection between the gear and door leaf, such a generator damped door closer also generally comprises, in turn, a spring serving as a mechanical store. When the door is opened manually the spring is tensioned, thereby loading potential energy into the spring. At the same time the gear assigned to the electric motor is rotated when the door is opened. The at least one electric motor is generally a magnetically excited direct current motor with or without brushes. Firstly this generates electrical energy for the open- or closed-loop control electronics from the leaf movement. Secondly the open- or closed-loop control electronics are able to damp the movement of the door leaf by short-circuiting the motor windings. In particular, the closing movement of the door leaf, caused by the releasing spring, can be damped under open- or closed-loop control via the open- or closed-loop control electronics after the door leaf is released, which may take place, for example, by means of pulse width modulation of the short-circuit as a function of the current position or current speed of the door leaf. Like a known hydraulically damped door closer, such a generator damped door leaf generally operates independently, i.e. it requires no external electrical energy source, either via the mains or via an accumulator.

The object of the invention is to propose a drive device of the above-mentioned type in which the previously mentioned disadvantages have been eliminated. Here the intention is, in particular, reliably to make safe possible hazard zones in the region of the at least partially automatically actuated leaf in the simplest, and hence the most cost-effective manner possible.

This object is achieved in accordance with the invention by a drive device having the features of claim 1. Preferred embodiments of the drive device according to the invention result from the dependent claims, the present description and the drawing.

The drive device according to the invention for a leaf of a door, of a window or the like comprises a drive with a mechanical store which is charged by an opening movement of the leaf and is discharged with a closing movement of the leaf, at least one electric motor which is in operative connection with the leaf via at least one motor shaft and is operable as a generator for damping the leaf movements, and open- and closed-loop control electronics for actuating the electric motor. The drive device also comprises a sensor system for monitoring at least one hazard zone in the region of the leaf. Moreover, the electric motor is actuatable via the open- and/or closed-loop control electronics as a function of the output signals of the sensor system, to make the hazard zone safe.

On the basis of this design the at least one electric motor of a generator damped drive or door closer, operated as a generator for damping the leaf movements, together with a sensor system, can also be used to make safe possible hazard zones in the region of the at least partially automatically actuated leaf, thereby ensuring that the hazard zones are made safe in as simple and reliable manner as possible.

Here a secondary closing edge of a respective door can, in particular, be monitored as a hazard zone by the sensor system.

Alternatively or additionally a main closing edge of a relevant door can also be monitored by the sensor system.

It is also advantageous, in particular, if a region located in front of the leaf, when viewed in the direction of movement of the leaf, during respective opening and/or closing movement of the leaf can be monitored as a hazard zone by the sensor system. This can also prevent a person from being struck by a door leaf on opening or closing.

According to a preferred practical embodiment of the drive device according to the invention, the sensor system comprises at least one contactless sensor and/or at least one tactile sensor.

Here the sensor system may comprise, for example, at least one active infrared light sensor, at least one switch strip, at least one active infrared sensor and/or the like.

According to a suitable, practical embodiment of the drive device according to the invention, the drive is provided with at least one interface via which at least one external sensor of the sensor system is connectable and can be connected to the open- and/or closed-loop control electronics of the drive. A respective interface or input may be of a digital and/or analogue design.

Also conceivable in principle, however, are embodiments of the drive device according to the invention in which at least one sensor of the sensor system is integrated in the drive.

It is also advantageous, in particular, if the drive is provided with at least one interface for the connection of at least one sensor for a DIN left door and with at least one interface for the connection of at least one sensor for a DIN right door, and/or comprises at least one integrated sensor for a DIN left door and one integrated sensor for a DIN right door.

For DIN left doors or DIN right doors for example two sensors, for example one sensor with a downwardly directed detection field and one sensor with an upwardly directed detection field, can be installed in a door closer or the drive device can be designed such that a sensor can be inserted at the bottom or top. Therefore one and the same generator damped door closer can be used both to make safe hazard zones in the case of DIN left doors and to make safe hazard zones in the case of DIN right doors.

According to a preferred practical embodiment of a drive device according to the invention, the functionality of the sensor system can be tested and/or monitored by the open- and closed-loop control electronics of the drive. The reliability with which possible hazard zones are made safe in the region of the automatically actuatable leaf is therefore increased correspondingly.

The open- and/or closed-loop control electronics of the drive is preferably designed such that if a hazard is detected by the sensor system in at least one monitored hazard zone, the speed of a respective closing and/or opening movement of the leaf is at least reduced by generator damping via the electric motor operable as a generator. Thus the angular velocity of the leaf can, for example, be reduced from 15°/second to 0.5°/second in order to minimise the risk of injury to a person present in a hazard zone. A preferred practical embodiment of the drive device according to the invention is characterised in that, in the presence of a hazard detected by the sensor system in at least one monitored hazard zone, the leaf can also be locked against the force of the mechanical store in that, via the open- and/or closed-loop control electronics, the electric motor may be acted on by external electrical energy and/or a braking device may be actuated to act on a motor shaft of the electric motor. The external electrical energy in question may, for example, derive from the mains, an accumulator, a battery and/or the like.

It is also advantageous, in particular, if the respective locking of the leaf may be released again via the open- and/or closed-loop control electronics after the sensor system has signalled the removal of the hazard.

According to a further suitable, practical embodiment of the drive device according to the invention, the open- and/or closed-loop control electronics are designed such that if a fault in the sensor system is detected, the speed of a respective closing and/or opening movement of the leaf is at least reduced by generator damping via the electric motor operable as a generator until the sensor system is again operating fault-free.

It is also advantageous if, when a fault in the sensor system is detected, the leaf is also lockable against the force of the mechanical store in that, via the open- and/or closed-loop control electronics, the electric motor may be acted on by external electrical energy and/or a braking device may be actuated to act on a motor shaft of the electric motor until the sensor system is again operating fault-free.

The sensor system can advantageously be switched to a sleep mode by means of the open- and/or closed-loop control electronics in pre-settable operating phases of the drive and/or at pre-settable times. In certain operating phases or at pre-settable times when a risk to persons can be virtually ruled out, energy can therefore be saved. For example, the sensor system can be transferred to sleep mode during manual opening of the leaf, when a mechanical energy store is charged, while the sensor system is activated during the automatic closing of the leaf caused by the stored energy in order to monitor the automatic closing. As mentioned previously, however, safety monitoring is also possible, in principle, during a respective opening movement of the leaf.

It is also advantageous, in particular, if the drive device comprises a warning device, particularly for acoustic and/or optical signalling of a respective hazard detected by the sensor system.

A respective interface of the drive for the connection of an external sensor of the sensor system may comprise, for example, a terminal, a plug, a radio connection and/or the like.

If the generator damped drive of the drive device is a generator damped door closer, the latter can, for example, be mounted as a top door closer in transom mounting, door leaf mounting, hinge side mounting, on the opposite side of the hinge and/or the like, integrated as an integrated door closer in the door leaf, as a bottom door closer and/or the like. In particular, in the mounting variant of door leaf mounting on the opposite side of the hinge, the sensor unit may, in particular, be integrated in the generator damped drive or door closer, wherein a respective sensor may in this case comprise, in particular, an active infrared sensor.

The invention is explained in more detail below on the basis of exemplary embodiments and with reference to the drawings, in which the following are shown:

FIG. 1 shows a schematic representation of exemplary hazard zones in the region of secondary closing edges of doors,

FIG. 2 shows a schematic representation of the basic structure of an exemplary embodiment of a drive device according to the invention,

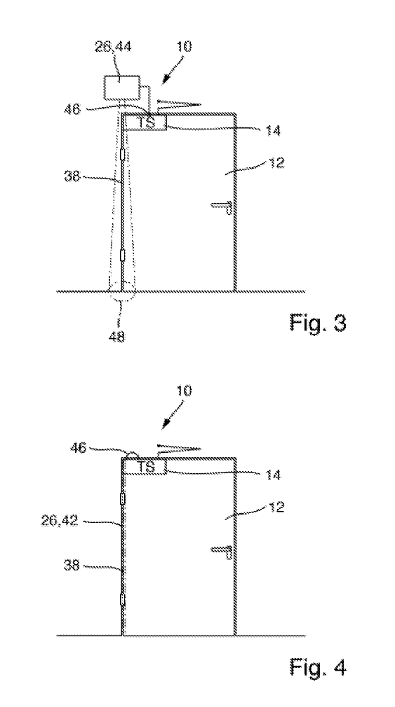

FIG. 3 shows a schematic representation of an exemplary embodiment of a drive device according to the invention whose drive is provided with an interface for the connection of an external sensor system comprising an active infrared sensor,

FIG. 4 shows a schematic representation of an exemplary embodiment of a drive device according to the invention whose drive is provided with an interface for the connection of an external sensor system comprising a switch strip,

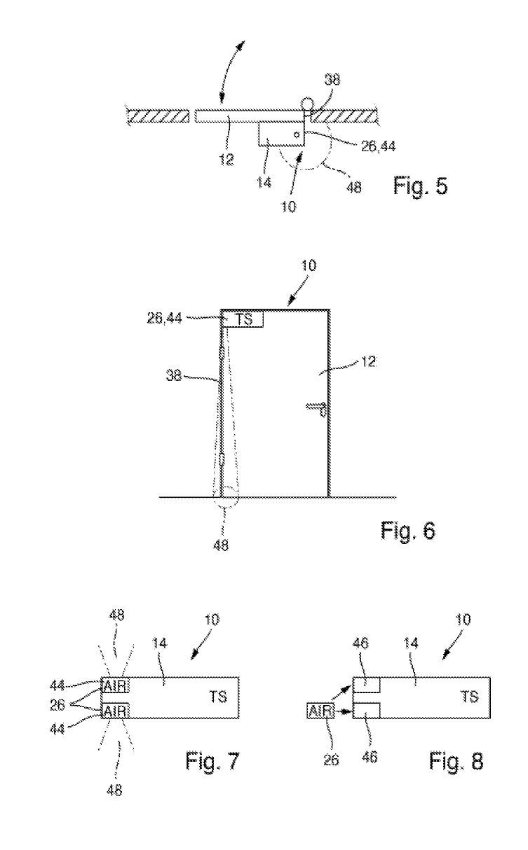

FIG. 5 shows a schematic representation of an exemplary embodiment of a drive device according to the invention with a sensor system integrated in the drive, wherein the sensor system in turn comprises an active infrared sensor, for example,

FIG. 6 shows a schematic representation of an exemplary embodiment of a drive device according to the invention with a sensor system integrated in the drive and comprising an active infrared sensor whose detection field covers the secondary closing edge of the respective door,

FIG. 7 shows a schematic side view of an exemplary drive of a drive device according to the invention with two sensors integrated in the drive with a detection field directed upwards and downwards respectively,

FIG. 8 shows a schematic side view of an exemplary drive of a drive device according to the invention with two interfaces for the connection of an external sensor in an upper and lower region respectively, and

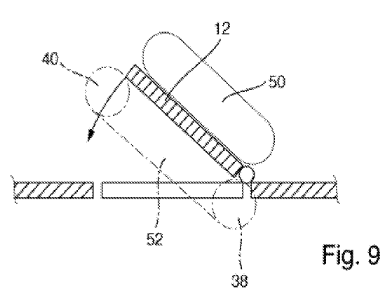

FIG. 9 shows a schematic representation of a plurality of hazard zones in the region of a door which can be monitored by a corresponding sensor system of a drive device according to the invention.

FIGS. 1 to 9 show different exemplary embodiments and exemplary applications of a drive device 10 according to the invention for a leaf 12 of a door, of a window or the like. Whilst in the exemplary embodiments shown in the drawings the drive device 10 is always provided for a leaf 12 of a door, the drive device 10 according to the invention may in principle also be used for a leaf of a window or the like.

FIG. 2 shows, in a schematic representation, the basic structure of an exemplary embodiment of the drive device 10 according to the invention. According thereto, drive device 10 comprises a drive 14 with a housing 16, a mechanical energy store 18 which is charged by an opening movement of leaf 12 and discharged with a closing movement of leaf 12, at least one electric motor 20 which is in operative connection with leaf 12 via at least one motor shaft 22 and is operable as a generator for damping the leaf movements, and open- and/or closed-loop control electronics 24 for actuating the electric motor 20.

Moreover, drive device 10 comprises a sensor system 26 for monitoring at least one hazard zone in the region or in the vicinity of leaf 12. Here electric motor 20 is actuatable via open- and/or closed-loop control electronics 24 as a function of the output signals of sensor system 26 to make safe the hazard zone.

Drive 14 is in this case fastened by means of its housing 16, for example, to leaf 12. Motor shaft 22 of electric motor 20 is coupled by means of a gear 28 to an output shaft 30 of drive 14, to which is non-rotatably connected in this case, for example, a slide arm 32 which is provided at its free end with a slide block 34 which is guided in a slide rail 36 mounted fixed to the faceplate.

A secondary closing edge 38 (cf. for example FIGS. 1, 3 to 6 and 9) of a respective door can for example be monitored by the sensor system 26 as a hazard zone. Alternatively or additionally a main closing edge 40 (cf. FIG. 9) of a respective door can also be monitored by the sensor system 26 as a hazard zone, for example.

However, also conceivable are embodiments of the drive device 10 according to the invention in which, alternatively or additionally, a region located in front of leaf 12, when viewed in the direction of movement of leaf 12, during a respective opening movement and/or closing movement of leaf 12 can be monitored as a hazard zone by sensor system 26 (cf. in particular FIG. 9 once again). The drive device 10 according to the invention can therefore also be used to prevent a person from being struck by leaf 12 during opening and/or closing and injured thereby.

Sensor system 26 can, in particular, comprise at least one contactless sensor and/or at least one tactile sensor. In this case sensor system 26 comprises, for example, at least one active infrared light sensor, at least one switch strip 42 (cf. FIG. 4), at least one active infrared sensor 44 (cf. FIGS. 3 and 5 to 7) and/or the like.

Drive 14 can be provided with at least one interface 46 (cf. FIGS. 3, 4 and 8) by means of which at least one external sensor of sensor system 26 is connectable and can be connected to the open- and/or closed-loop control electronics 24 of drive 14.

Also conceivable, however, are embodiments of the drive device according to the invention 10 in which at least one sensor of the sensor system 26 is integrated in drive 14 (cf. FIGS. 5 to 7)

FIG. 3 shows an exemplary embodiment of the drive device 10 according to the invention whose drive 14 is provided with an interface 46 for the connection of an external sensor system 26 comprising an active infrared sensor 44. In the embodiment shown in FIG. 4, drive 14 is provided with an interface 46 for the connection of an external sensor system 26 comprising a switch strip 42.

FIG. 5 shows an exemplary embodiment of the drive device 10 according to the invention with a sensor system 26 integrated in drive 14 and comprising an active infrared sensor 44, the detection field 48 of which sensor system covers the secondary closing edge 38 of the respective door. FIG. 6 shows an exemplary embodiment of the drive device 10 according to the invention with a sensor system 26 integrated in drive 14 and comprising an active infrared sensor 44, the detection field 48 of which sensor system covers the secondary closing edge 38 of the respective door.

As may be seen in FIGS. 7 and 8 in particular, drive 14 may also be provided, for example, with at least one interface 46 for the connection of at least one sensor for a DIN left door, and with at least one interface 46 for the connection of at least one sensor for a DIN right door (cf. FIG. 7) and/or at least one integrated sensor for a DIN left door and one integrated sensor for a DIN right door (cf. FIG. 8).

The open- and/or closed-loop control electronics 24 of drive 14 may also be designed such that the functionality of sensor system 26 can also be tested and/or monitored by means of these open- and/or closed-loop control electronics 24.

Moreover, the open- and/or closed-loop control electronics 24 of a respective drive 14 may, in particular, also be designed such that in the presence of a hazard detected by sensor system 26, in at least one monitored hazard zone, the speed of a respective closing and/or opening movement of leaf 12 is at least reduced by generator damping by means of electric motor 20 operable as a generator. Moreover, in the presence of a hazard detected by sensor system 26 in at least one monitored hazard zone, leaf 12 can also be locked or stopped against the force of mechanical store 18 in that, via the open- and/or closed-loop control electronics 24, the electric motor 20 may be acted on by external electrical energy and/or a braking device may be actuated to act on a motor shaft 22 of electric motor 20. Here the respective locking of leaf 12 by means of open- and/or closed-loop control electronics 24 can also be released again after the sensor system 26 has signalled the removal of the hazard.

If the functionality of sensor system 26 can be tested and/or monitored by means of the open- and/or closed-loop control electronics 24 of drive 14, the open- and/or closed-loop control electronics may also be designed such that, if a fault is detected in sensor system 26, the speed of a respective closing and/or opening movement of leaf 12 is at least reduced by generator damping by means of electric motor 20 operable as a generator until sensor system 26 is again operating fault-free. If a respective fault is detected in sensor system 26, leaf 12 is also lockable against the force of mechanical store 18. For this purpose, via the open- and/or closed-loop control electronics 24 electric motor 20 may be acted on by external electrical energy and/or a braking device may be actuated to act on a motor shaft 22 of electric motor 20, until the sensor system 26 is again operating fault-free.

The open- and/or closed-loop control electronics 24 may also be designed such that sensor system 26 can also be switched to a sleep mode in pre-settable operating phases of drive 14 and/or at pre-settable times in order to save energy. A corresponding embodiment is conceivable, for example, when no external electrical energy is required. Sensor system 26 may be switched to a sleep mode for example during opening of leaf 12, during which the mechanical energy store 18 is charged. On the other hand sensor system 26 may, for example, be activated during a respective closing process of leaf 12 effected by the mechanical store 18, in order to monitor this automatic closing. In principle, however, monitoring of certain hazard zones by activated sensor system 26 during a respective opening movement of leaf 12 is also conceivable.

Moreover, the respective drive device 10 may also comprise a warning device for, in particular, acoustic and/or optical signalling of a respective hazard detected by sensor system 26.

If a respective drive 14 is provided with at least one interface 46 for the connection of an external sensor of sensor system 26, such an interface 46 may, for example, comprise a terminal, a plug, a radio connection and/or the like.

### LIST OF REFERENCE NUMERALS

10 Drive device
12 Leaf
14 Drive
16 Housing
18 Mechanical energy store
20 Electric motor
22 Motor shaft
24 Open- and/or closed-loop control electronics
26 Sensor system
28 Gear
30 Output shaft
32 Slide arm
34 Slide block
36 Slide rail
38 Secondary closing edge
40 Main closing edge
42 Switch strip
44 Active infrared sensor
46 Interface
48 Detection field
50 Hazard zone
52 Hazard zone

1. A drive device (10) for a leaf (12) of a door, of a window or the like, with a drive (14) with a mechanical store (18) which is charged by an opening movement of the leaf (12) and is discharged by a closing movement of the leaf (12), at least one electric motor (20) which is in operative connection, by means of at least one motor shaft (22), with the leaf (12), and is operable as a generator for damping the leaf movements, and with open- and/or closed-loop control electronics (24) for actuating the electric motor (20), wherein the drive device (10) also comprises a sensor system (26) for monitoring at least one hazard zone (38, 40, 50, 52) in the region of the leaf (12) and the electric motor (20) is actuatable by means of the open- and/or closed-loop control electronics (24) as a function of the output signals of the sensor system (26) to make safe the hazard zone.

2. The drive device according to claim 1 wherein a secondary closing edge (38) of a respective door can be monitored by the sensor system (26) as a hazard zone.

3. The drive device according to claim 1 wherein a main closing edge (40) of a respective door can be monitored by the sensor system (26) as a hazard zone.

4. The drive device according to claim 1 wherein a region (50, 52) located in front of the leaf, when viewed in the direction of movement of the leaf (12), during a respective opening movement and/or closing movement of the leaf (12) can be monitored by the sensor system (26) as a hazard zone.

5. The drive device according to claim 1 wherein the sensor system (26) comprises at least one contactless sensor and/or at least one tactile sensor.

6. The drive device according to claim 5 wherein the sensor system (26) comprise at least active infrared light sensor, at least one switch strip (42), at least one active infrared sensor (44) and/or the like.

7. The drive device according to claim 1 wherein the drive (14) is provided with at least one interface (46) via which at least an external sensor of the sensor system (26) is connectable and can be connected to the open- and/or closed-loop control electronics (24) of the drive (14).

8. The drive device according to claim 1 wherein at least one sensor of the sensor system (26) is integrated in the drive (14).

9. The drive device according to claim 8 wherein the drive (14) is provided with at least one interface (46) for the connection of at least one sensor for a DIN left door and with at least one interface (46) for the connection of at least one sensor for a DIN right door, and/or comprises at least one integrated sensor for a DIN left door and one integrated sensor for a DIN right door.

10. The drive device according to claim 1 wherein the functionality of the sensor system (26) can be tested and/or monitored by means of the open- and/or closed-loop control electronics (24) of the drive (14).

11. The drive device according claim 1 wherein the open- and/or closed-loop control electronics (24) of the drive (14) are designed such that, in the presence of a hazard detected by the sensor system (26) in at least one monitored hazard zone (38, 40), the speed of a respective closing and/or opening movement of the leaf (12) is at least reduced by generator damping by means of the electric motor (20) operable as a generator.

12. The drive device according to claim 1 wherein in the presence of a hazard detected by the sensor system (26) in at least one monitored hazard zone, the leaf (12) is lockable against the force of the mechanical store (18) in that, via the open- and/or closed-loop control electronics (24), the electric motor (20) may be acted on by external electrical energy and/or a braking device may be actuated to act on a motor shaft (22) of the electric motor (20).

13. The drive device according to claim 1 wherein the respective locking of the leaf (12) can be released again by means of the open- and/or closed-loop control electronics (24) after the sensor system (26) has signalled the removal of the hazard.

14. The drive device according to claim 1 wherein the open- and/or closed-loop control electronics (24) are designed such that, if a fault is detected in the sensor system (26), the speed of a respective closing and/or closing movement of the leaf (12) is at least reduced by generator damping by means of the electric motor (20) operable as a generator until the sensor system (26) is again operating fault-free.

15. The drive device according to claim 1 wherein if a fault is detected in the sensor system (26), the leaf (12) is lockable against the force of the mechanical store (18) in that, via the open- and/or closed-loop control electronics (24), the electric motor (20) may be acted on by external electrical energy and/or a braking device may be actuated to act on a motor shaft (22) of the electric motor (20) until the sensor system (26) is again operating fault-free.

16. The drive device according to claim 1 wherein the sensor system (26) can be switched to a sleep mode by means of the open- and/or closed-loop control electronics (24) in pre-settable operating phases of the drive (14) and/or at pre-settable times.

17. The drive device according to claim 1 wherein the drive device (10) comprises a warning device for, in particular, acoustic and/or optical signalling of a respective hazard detected by the sensor system (26).
